(19) United States
(12) Patent Application Publication
(10) Pub. No.: US 2021/0370389 A1
(43) Pub. Date: Dec. 2, 2021

(54) WASTE ALUMINIUM BASED MULTILAYER HYBRID AND FUNCTIONAL GRADED COMPOSITE FOAM AND THE PRODUCTION METHOD THEREOF

(71) Applicant: ONDOKUZ MAYIS UNIVERSITESI, Samsun (TR)

(72) Inventor: Mevlut Gurbuz, Samsun (TR)

(73) Assignee: ONDOKUZ MAYIS UNIVERSITESI, Samsun (TR)

(21) Appl. No.: 17/290,941

(22) PCT Filed: Oct. 14, 2019
(86) PCT No.: PCT/TR2019/050863

§ 371 Date: May 3, 2021

(30) Foreign Application Priority Data
Nov. 16, 2018 (TR) 2018/17369

(51) Int. Cl. B22D 25/00; B22D 25/06; B22D 19/16; C22C 1/08

(52) U.S. Cl. CPC B22D 25/005; B22D 25/06; C22C 2001/083; C22C 1/08; B22D 19/16

(57) ABSTRACT

The present invention relates to multi-layered hybrid and functional graded aluminum foam obtained from waste aluminum beverage cans, and to the production method thereof. This multi-layered aluminum composite foam can be used in bullet-proof armors in many fields such as aviation, defense industry, automotive and rail systems, in decreasing the impact effect in fast trains and automobiles, in vibration damping, in absorbing energy during impact and shock, in electromagnetic shields, as air buffer panel in carrying heavy vehicles such as tanks, in providing sound insulation on motorways and for flame retardant purposes.

### TECHNICAL FIELD

The present invention relates to multi-layered hybrid and functional graded aluminum foam obtained from waste aluminum beverage cans, and to the production method thereof.

### STATE OF THE ART (PRIOR ART)

Aluminum foam materials are the structures obtained by using pure metal or alloys at least 70% of which are composed of pores. Aluminum foams have been widely used for years, in bullet-proof armors, in decreasing the impact effect in fast trains and automobiles, in vibration damping, in absorbing energy during impact and shock, in electromagnetic shields, as air buffer panel in carrying heavy vehicles such as tanks, in providing sound insulation on motorways and in flame retardant applications.

In the practices within the state of the art, aluminum foams are produced by dust metallurgy methods wherein powders obtained by very expensive and primary aluminum production and by using pore-making materials by melting these expensive powders. Moreover, in order to improve the features of these foams in studies, it is also produced in composite form by using powders such as alumina, silicon carbide, boron carbide alone. Also, functional gradual foam production is present.

Chinese patent application no. CN 1424416 A relates to aluminum foam composite and the production method thereof. The foam composite mentioned here includes closed micro pores. Another patent application no. U.S. Pat. No. 5,516,592 A in the prior art; the present invention relates to foam composites comprising aluminum alloy and the production methods thereof.

The aluminum foams produced in the present studies damp the energy to a certain value as they are subjected to mechanical effect, but the product is completely deformed. Also; expensive aluminum powders are used in existing aluminum foam production.

The present invention relates to both functional graded and hybrid aluminum multi-layer composite foam obtained by using waste aluminum cans/containers, preferably beverage cans/containers, easily obtainable as waste, and to the production method thereof.

### BRIEF DESCRIPTION AND OBJECTS OF THE INVENTION

The present invention relates to multi-layer aluminum composite foam in hybrid form and functional graded.

The biggest advantage of the composite foam according to the invention is that the foam produced has two layers. The first layer is dense, hybrid and functional graded and the second layer is in hybrid form; the said composite foam is multi-layered, so that under the mechanical action, even if the top layer is deformed, it is not deformed as energy is absorbed by the bottom layer. Therefore, this composite foam has a very high mechanical property and is capable of absorbing energy.

In the present invention, composite and hybrid-form aluminum foam is produced from waste beverage cans for the first time, differently from the existing foams. This provides both low cost and easy raw material output. In addition, the environmental damage has been reduced since recycling is provided and savings are provided in terms of limited resources.

### DESCRIPTION OF THE FIGURES

FIG. 1 illustrates the inventive multi-layered composite foam.

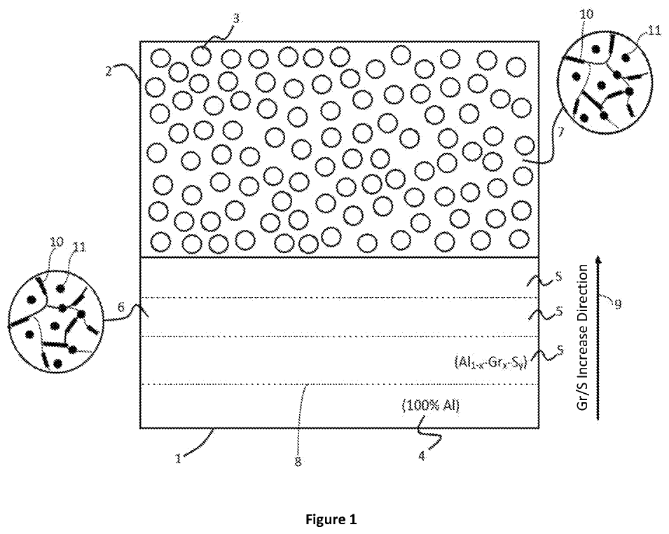

### DESCRIPTION OF THE ELEMENTS/PARTS/PIECES COMPOSING THE INVENTION

In order to better explain the multi-layer aluminum composite foam in hybrid form and functional graded developed by the present invention, the pieces and parts in the figures are numbered and the corresponding number of each is given below:
1. Dense layer
2. Foam (pored) layer
3. Foam (pore)
4. 100% aluminum layer
5. Functional graded layer in hybrid structure
6. Micro structure of functional graded layer in hybrid structure
7. Cell wall micro structure
8. Layered transition layer
9. Graphene and ceramic increase direction
10. Graphene
11. Ceramic

### DETAILED DESCRIPTION OF THE INVENTION

The present invention is multi-layered composite foam having at least four layers and it comprises a dense layer (1) comprising 100% aluminum layer (4) and at least two hybrid structure and functional graded layers (5) at one end and foam layer (3) in hybrid structure at the other end.

In the production of multi layered aluminum (Al) composite foam subject to the invention; hybrid-structured foam (2) is obtained by reinforcing graphene (Gr) and ceramic (S) powders (boron carbide, silicon nitride, silicon carbide, boron nitride etc.) together. Functional graded layers in hybrid structure within the dense layer are obtained by altering graphene and ceramic gradually. By dense layer herein, what is meant is the layer comprising at one end 100% aluminum layer as well as the hybrid structured functional grade layer/layers including aluminum and/or graphene and/or ceramic. The multi-layer aluminum composite foam has 100% aluminum layer (4) at one end and the foam layer (2) at the other end, i.e. these two layers are the farthest away from each other.

In the invention, sodium chloride (NaCl), preferably spherical sodium chloride is used as foam/pore making agent.

Products are manufactured by using the method of melting and then casting. In this method, first the dense layer is produced layer by layer in hybrid form and in functional grades.

The multi layered aluminum foam composition subject to the invention has the formula of Al₍₁₋ₓ₎GrₓS_{y}. Here; x varies in the range of 0-5% by weight and y varies in the range of 0-30% by weight.

The production method for the -hybrid and functional graded multi layered aluminum composite foam subject to the invention comprises below steps:
i. Melting the waste aluminum cans/containers,
ii. Casting so as to make one end of the multi layered aluminum composite foam 100% aluminum layer,
iii. Making gradual casting for different ratios of aluminum, graphene and ceramic in melted in a different melting pot, while that layer is in semi-solid state,
iv. Obtaining the hybrid and functional graded dense layer by repeating the step (ii) until the layer that contains maximum ceramic amount is obtained, when that layer becomes semi-solid,
v. Adding the solution and foaming/pore-forming agent including aluminum, graphene and ceramic amounts in different ratios, onto the dense functional graded layer in semi-solid form, and then and mixing them,
vi. Adding the resulting multilayer structure to water and boiling above 100° C., removing the foaming/pore-forming agent and forming the hybrid layer foam layer at the other end of the multilayer aluminum composite foam to obtain the final product multilayer aluminum composite foam.

In production, cast is performed so as to have 100% Al (x=0%, y=0%) at one end of the dense layer and gradual casting is performed for varying x and y ratios which are melted in another melting pot while in a semi-solid state (e.g.; Al_{99.85}Gr_{0.15}Si). When this layer becomes semi-solid, the previous process is repeated for different x and y ratios. Finally, the same process is repeated until the layer containing the maximum amount of ceramic (y=30%) is obtained. After the hybrid functional grade dense layer is obtained, the solution containing different amounts of x and y in hybrid form (Al₍₁₋ₓ₎GrₓS_{y}) is mixed onto the semi-solid product so as to contain NaCl pore maker and the hybrid form foam layer is obtained by adding it onto the semi-solid product. The amount of NaCl is added in such a way that 50-90% porosity is obtained. The resulting two-layer structure is then added to water boiled above 100° C. and NaCl is removed. Thus, since the salt within the foam layer is removed, foam layer in hybrid form is obtained.

In an embodiment, the waste aluminum can/container is aluminum beverage can/container.

The invention can be used in bullet-proof armors in many fields such as aviation, defense industry, automotive and rail systems, in decreasing the impact effect in fast trains and automobiles, in vibration damping, in absorbing energy during impact and shock, in electromagnetic shields, as air buffer panel in carrying heavy vehicles such as tanks, on motorways and for flame retardant purposes.

1. Multi layered aluminum composite foam, characterized in that it comprises a dense layer (1) comprising 100% pure aluminum layer (4) at one end of the composite foam and at least two hybrid and functional graded layers (5) and foam layer (3) in hybrid structure at the other end of the composite foam.

2. An aluminum composite foam according to claim 1, characterized in that the aluminum source is waste aluminum.

3. An aluminum composite foam according to claim 1, characterized in that the aluminum source is waste aluminum can/container.

4. An aluminum composite foam according to claim 3, characterized in that the aluminum source is waste aluminum beverage can/container melt.

5. An aluminum composite foam according to claim 1, characterized in that the layers comprise at least one of aluminum, graphene and ceramic or any combination thereof.

6. An aluminum composite foam according to claim 5, characterized in that ceramic is in powder form.

7. An aluminum composite foam according to claim 4, characterized in that ceramic powder includes boron carbide, silicon nitride, silicon carbide and/or boron nitride.

8. An aluminum composite foam according to claim 1, characterized in that it has the formula of Al₍₁₋ₓ₎GrₓS_{y}.

9. An aluminum composite foam according to claim 8, characterized in that; x and y are percentages by weight.

10. An aluminum composite foam according to claim 9, characterized in that; x is between the range of 0-5% by weight and y is between the range of 0-30% by weight.

11. A production method of multi layered aluminum composite foam according to any one of the preceding claims, characterized by comprising below steps;
i. Melting the waste aluminum cans/containers,
ii. Casting so as to make one end of the multi layered aluminum composite foam 100% pure aluminum by using the melted waste aluminum can,
iii. Making gradual casting for different ratios of aluminum, graphene and ceramic in melted in a different melting pot, while that layer is in semi-solid state,
iv. Obtaining the hybrid and functional grade dense layer by repeating the step (ii) until the layer that contains maximum ceramic amount is obtained, when that layer becomes semi-solid,
v. Adding the solution and foam/pore making agent including aluminum, graphene and ceramic amounts in different ratios, onto the dense functional grade layer in semi-solid form, and then and mixing them,
vi. Adding the resulting multilayer structure to water and boiling above 100° C., removing the foaming/pore-forming agent and forming the hybrid layer foam layer at the other end of the multilayer aluminum composite foam to obtain the final product multilayer aluminum composite foam.

12. A production method according to claim 11 characterized in that in process step (v), the foaming/pore-forming agent is added such that a porosity of 50-90% of the dense functional grade layer can be obtained.

13. A production method according to claim 11, characterized in that the foamin/pore-forming agent is sodium chloride.

14. A production method according to claim 13, characterized in that the foam/pore making agent is spherical sodium chloride.

15. A production method according to claim 11, the waste aluminum can/container is aluminum beverage can/container.

16. Use of multi-layer aluminum composite foam according to claim 1 in aerospace, defense industry, automotive and rail systems.

17. Use of multi-layer aluminum composite foam according to claim 1 in in bullet-proof armors, in decreasing the impact effect in fast trains and automobiles, in vibration damping, in absorbing energy during impact and shock, in electromagnetic shields, as air buffer panel in carrying heavy vehicles, in providing sound insulation on motorways and for flame retardant purposes.
